(19) United States
(12) Patent Application Publication
(10) Pub. No.: US 2009/0250069 A1
(43) Pub. Date: Oct. 8, 2009

(54) Migraine headache relief pillow

(76) Inventor: Steven J. Frey, Dearborn Heights, MI (US)

Correspondence Address: Steven J. Frey, 3955 Mayfair Street, Dearborn Heights, MI, 48125-3039, US

(21) Appl. No.: 12/384,527

(22) Filed: Apr. 4, 2009

Related U.S. Application Data
(60) Provisional application No. 61/123,298, filed on Apr. 7, 2008.

(51) Int. Cl. A61G 15/00; A47G 9/10

(52) U.S. Cl. 128/845; 5/636; 5/640

(57) ABSTRACT

A pillow that provides relief from migraine headaches and is comfortable enough to allow for sleep. Within the structure of a soft pillow, is a spherical, hemispherical or conical shaped nodule, which is harder than the surrounding pillow. While the pillow provides support for the head to facilitate sleeping, the nodule provides passive and constant pressure to a single point of contact on the head.

### RELATED APPLICATIONS

The present application is a continuation-in-part application of U.S. provisional patent application, Ser. No. 61/123,298, filed Apr. 7, 2008, for MIGRAINE HEADACHE RELIEF PILLOW, by Steven J. Frey, included by reference herein and for which benefit of the priority date is hereby claimed.

### FIELD OF THE INVENTION

The present invention relates to pillows and, more particularly, to a pillow that reduces the severity and duration of migraine attacks

### BACKGROUND OF THE INVENTION

Thirty five million Americans (more than ten percent of the US population) suffer from migraine headaches. Fifteen million Americans (five percent of the US population) suffer from transformed (chronic daily) migraine headaches, a condition characterized by fifteen or more headache days per month. Sufferers experience substantial decreases in functioning and productivity, results which in turn translate into diminished quality of life for individuals, financial burdens for health care systems and substantial lost work time that impacts individuals, employers, and societies alike. Migraine is a condition most prevalent in individuals between the ages of twenty five and fifty five, generally the most productive years of a person's life. Lost labor costs in the United States due to migraine are in excess of thirteen billion dollars per year.

A migraine begins when blood vessels in the brain constrict temporarily. When that happens, the amount of blood and oxygen flowing to the brain drops. To protect itself, the brain sends electrochemical messages to the other blood vessels to increase blood flow (up to three hundred percent), causing them to dilate. When those blood vessels in the head expand, the once solid walls of the vessels become permeable and some fluid leaks out. (At times, this can be severe enough to cause localized edema of the scalp.) This leakage is recognized by pain receptors in the blood vessels of surrounding tissue. In response, the body supplies the area with chemicals which cause inflammation. With each heart beat, blood passes through this sensitive area causing a throb of pain. Because it involves changes in blood vessels, a migraine is a vascular headache, and often worsens with physical activity. Due to the sufferer's particular episode and individual physiology, the pain is most commonly on one side of the head and focused at a particular location.

Americans spend more than four billion dollars annually on drugs to stop migraine pain. Over the counter (OTC) pain medicines are often an important and effective treatment for migraine, tension and sinus headaches, however, using these drugs more than twice a week or so (especially those that contain caffeine) can actually cause headaches. This phenomenon, known as a “rebound” or medication-overuse headache locks the sufferer into a vicious cycle of rebound pain, followed by more OTC medication use, followed by more rebound pain. Many sufferers turn to prescription medicines to treat their pain, but studies have found that the use of commonly prescribed medications is associated with an increased risk of transformed migraine headaches, and overuse of these medications can actually make the symptoms of migraine worse. Since pain medications are less than one hundred percent effective, attempting to interrupt the natural cycle of a migraine with medication may actually prolong the symptoms. Letting a migraine “run its course” by not using a painkiller can sometimes decrease the length of an episode. This is especially true of cases where vomiting is common, as often the migraine will subside immediately after vomiting. Curbing the pain may delay vomiting, and prolong the migraine.

When a migraine attack begins, sufferers instinctively treat themselves by altering their environment. They will seek out dark, quite rooms, in an attempt to sleep, as when a person awakes the symptoms will have most likely subsided. Unfortunately for most sufferers, the pain of a migraine is too severe to allow for sleep.

The other behavior exhibited by both migraine and tension headache sufferers is to apply pressure with their fingers to the area of the head where the pain is focused. (This technique is commonly referred to as acupressure.) This is effective because this compresses the blood vessels and other tissue between the scalp and the skull. Physically constricting the blood vessels in this way prevents the localized inflammation of blood vessels and tissues, thereby relieving the pain. Many times relief can be found by applying pressure to an area of the head that is not experiencing pain, by reducing the amount of blood flow to the inflamed areas.

If these two most effective migraine treatments (sleep and acupressure) were to be combined in a single treatment, the severity and duration of attacks can be dramatically reduced. Unfortunately it is difficult, if not impossible, for an individual to fall asleep while simultaneously applying pressure to their head, themselves. If the sufferer does manage to fall asleep, their arm, hand and fingers relax and the acupressure ceases. The blood vessels and tissues return to their inflamed condition, as does the pain, causing the sufferer to awaken.

Over the years, several Shiatsu (Japanese from shi, meaning finger, and atsu, meaning pressure) massage pillows have been introduced to relieve muscle soreness and tension. Such devices are disclosed by U.S. Pat. No. 6,024,762, U.S. Pat. No. 5,481,771, U.S. Pat. No. 4,754,513 and U.S. Pat. No. 6,305,040.

While these prior art devices may provide relief from sore and tired muscles, and at times may reduce the discomfort of a tension headache, they do not address, nor are they capable of relieving the pain of a migraine headache. All of these prior art devices incorporate two or more rigid nodules to cradle the neck, thus applying pressure to the neck. This is not effective in treating a migraine headache, as the therapeutic pressure must be applied directly to the pain center in the head, or the vessels in the head that supply blood to the pain centers. Simply repositioning the head to rest on the nodules, rather than the neck, will fail to provide relief for two reasons. First, the migraine sufferer needs to apply pressure to only a single point on the head. The plurality of nodules on these prior art devices prevents this, and may actually cause additional pain to areas of the head not affected by the migraine. Secondly, since the nodules are raised above the surface of the underlying pillow structure, the user's head can not lay on the device in such a way to utilize the pressure producing nodule, while supporting the entire head for a comfortable, restful sleep.

It is therefore an object of the invention to provide a pillow for the relief of migraine headaches.

It is another object of the invention to provide a soft, comfortable support for the head to facilitate sleeping.

It is another object of the invention to provide a means of applying constant pressure to a single point of contact on the head.

### SUMMARY OF THE INVENTION

In accordance with the present invention, there is provided a pillow that provides relief from migraine headaches and is comfortable enough to allow for sleep. Within the structure of a soft pillow, is a spherical, hemispherical or conical shaped nodule, which is harder than the surrounding pillow. While the pillow provides support for the head to facilitate sleeping, the nodule provides passive and constant pressure to a single point of contact on the head.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a perspective view of a transverse section a-a of the device in use;

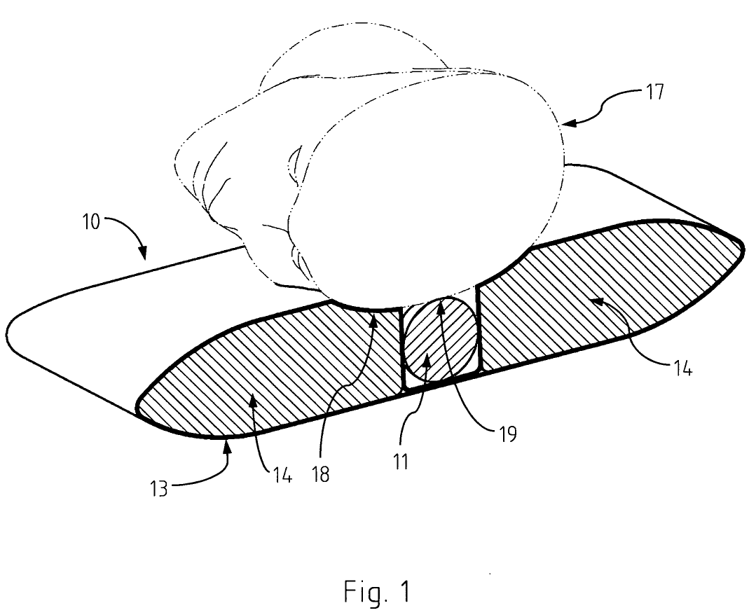

FIG. 2 is a perspective view of a coronal section b-b of the device in use;

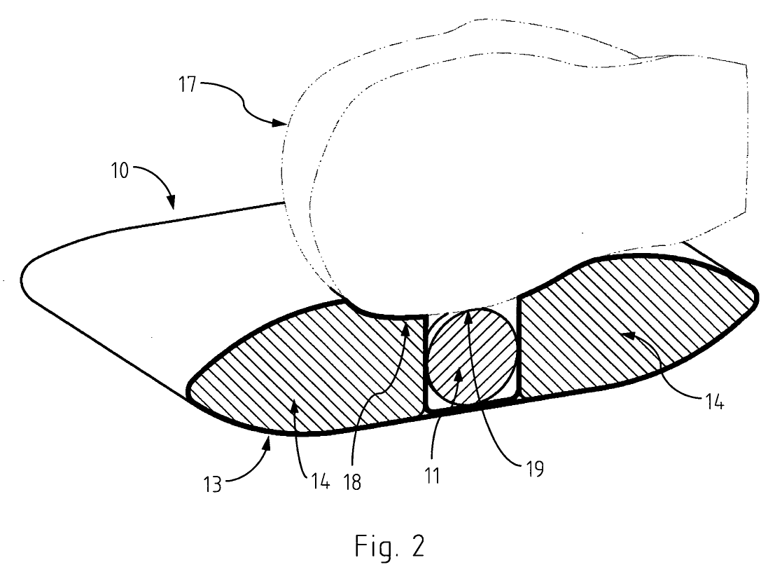

FIG. 3 is a sagittal view of the device in use, indicating the locations of transverse section a-a and coronal section b-b;

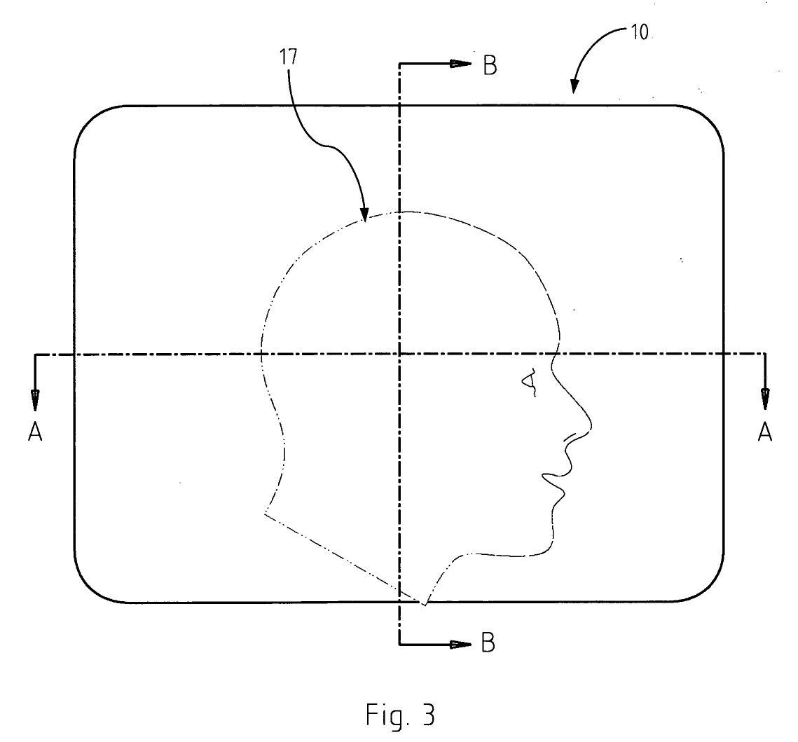

FIG. 4 is a partially exploded perspective view of the device;

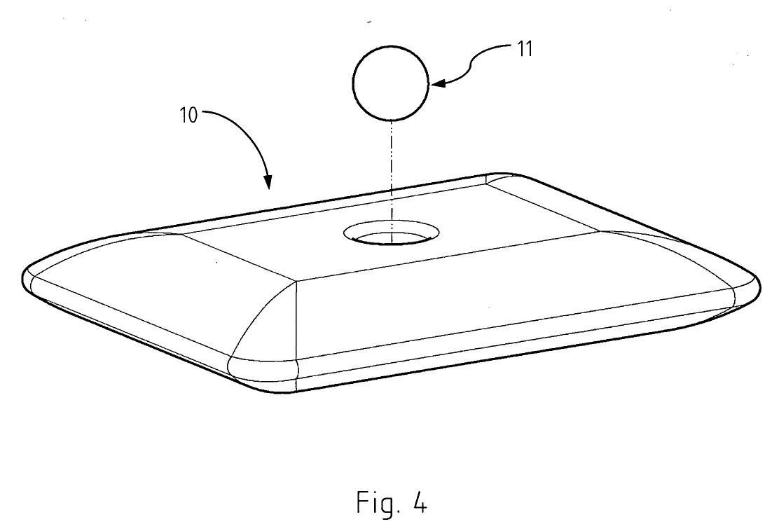

FIG. 5 is a plan view of the device, indicating the location of section c-c;

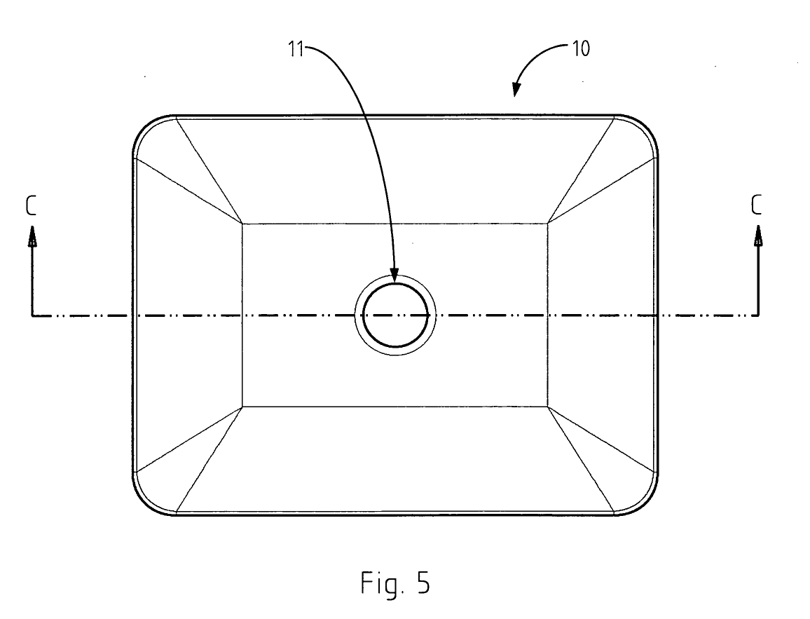

FIG. 6 is a perspective view of a section c-c of the device;

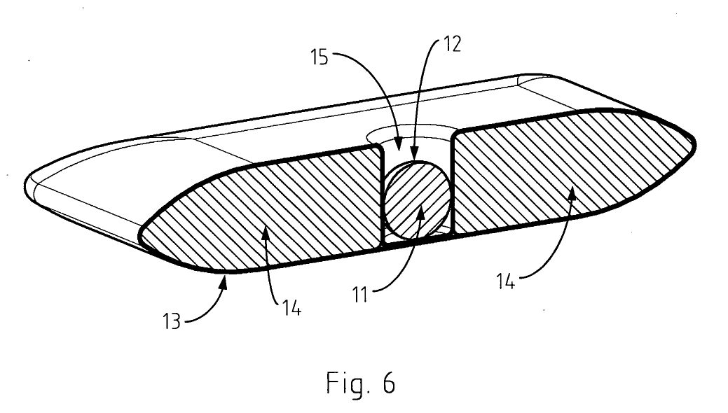

FIG. 7 is an exploded perspective view of a section c-c of the device;

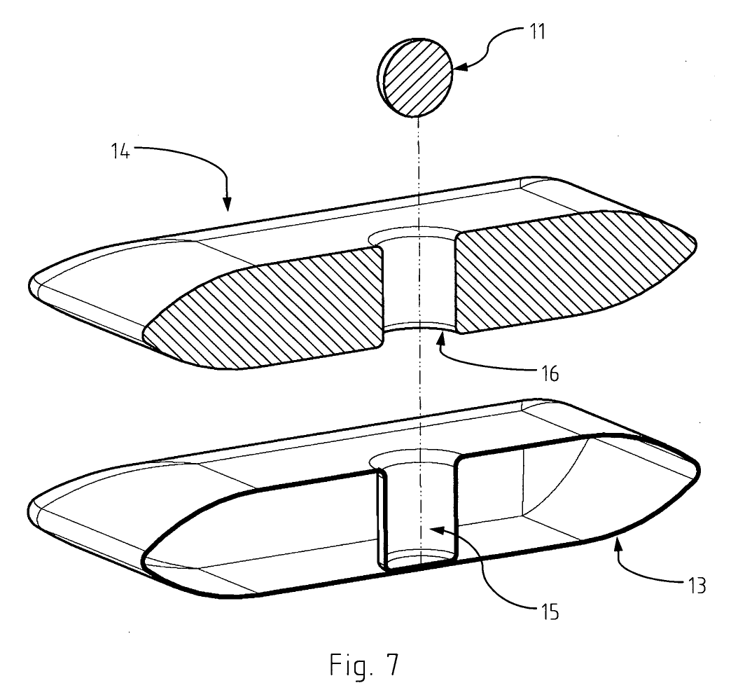

FIG. 8 is an elevation view of a section c-c of the device; and

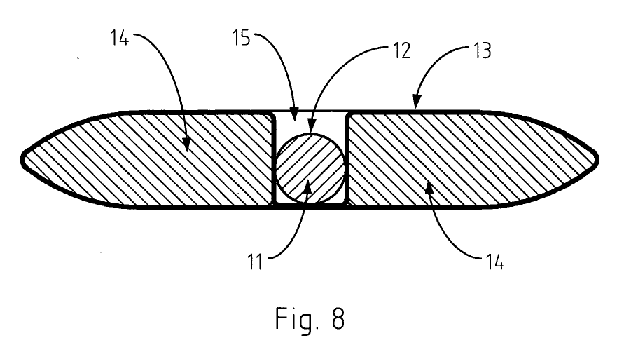

FIG. 9 is a partial section view of the human head.

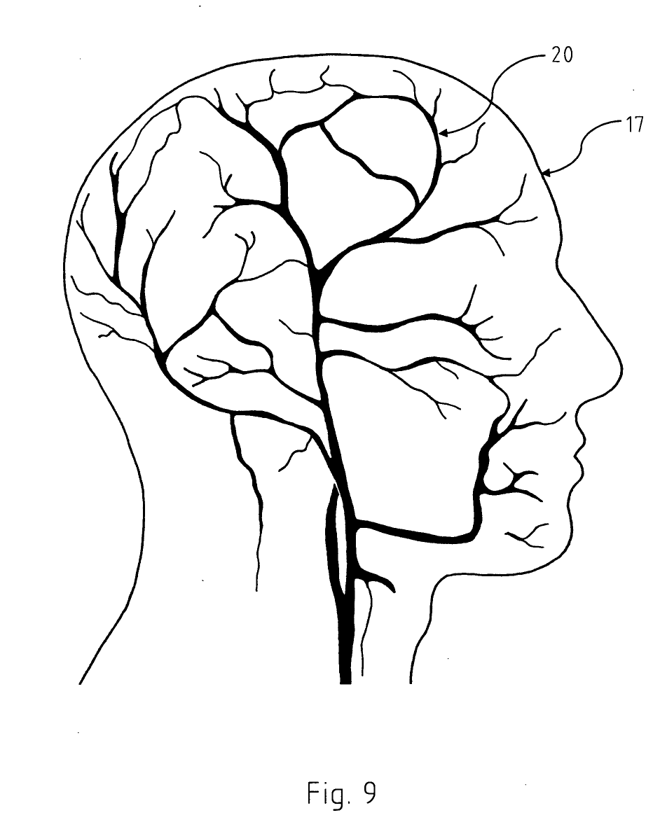

For purposes of clarity and brevity, like elements and components will bear the same designations and numbering throughout the Figures.

### DESCRIPTION OF THE PREFERRED EMBODIMENT

The current invention consists of a pillow 10 with a removable nodule 11. The preferred shape of the nodule 11 is spherical, but may also be hemispherical or conical, with a domed top 12. The nodule 11 may be made from plastic or rubber with various durometers (hardness) or of a material which can be frozen. The pillow 10 is of standard bedding size and shape, comprising a fabric covering 13 and filling 14 made from feathers, polyester fiber, foam, or other suitable material. The covering 13 incorporates a pocket 15 to retain the nodule 11. The filling 14 contains a void 16 to accommodate the pocket 15 which retains and maintains the position of the nodule 11.

During use, the nodule 11 is placed inside the pocket 15. The head 17 is rested on the pillow 10. The weight of the head 17 is supported by the filling 14, and is slightly compressed, forming a depression 18. The head 17 is positioned such that the top 12 of the nodule 11 makes contact with the head 17 at the exact area of pain 19.

The natural weight of the head 17 presses against the nodule 11 which provides counter pressure at the exact area of pain 19. This pressure provides pain relief for the user by restricting the flow of blood through the blood vessels 20. As the exact area of pain 19 migrates (moves) during the course of a migraine episode, the user may adjust the position of the head 17 as desired. As the user sleeps, the counter pressure provided by the nodule 11 is maintained. If desired, the nodule 11 may be frozen prior to use, to provide cold therapy, as well as acupressure therapy.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A migraine headache relief pillow for reducing the severity and duration of migraine attacks, comprising:
means for comfortably supporting the head to provide a restful sleep;
means for providing pressure to a single point of contact on the head; and
means for providing support for the head.

2. The migraine headache relief pillow in accordance with claim 1, wherein said means for comfortably supporting the head to provide a restful sleep comprises a soft, square, rectangular or cylindrical pillow.

3. The migraine headache relief pillow in accordance with claim 1, wherein said means for providing pressure to a single point of contact on the head comprises a semi-rigid, spherical, hemispherical or conical, removable nodule.

4. The migraine headache relief pillow in accordance with claim 1, wherein said means for providing support for the head comprises a soft, consisting of feathers, polyester fiber, low-density foam, or other suitable material filling.

5. A migraine headache relief pillow for reducing the severity and duration of migraine attacks, comprising:
a soft, square, rectangular or cylindrical pillow, for comfortably supporting the head to provide a restful sleep;
a semi-rigid, spherical, hemispherical or conical, removable nodule, for providing pressure to a single point of contact on the head; and
a soft, consisting of feathers, polyester fiber, low-density foam, or other suitable material filling, for providing support for the head.

6. The migraine headache relief pillow as recited in claim 5, further comprising:
a fabric, flexible, soft covering, for providing a surface to rest the head and retain the shape of the pillow.

7. The migraine headache relief pillow as recited in claim 5, further comprising:
a cylindrical pocket, for locating and retaining the nodule.

8. The migraine headache relief pillow as recited in claim 6, further comprising:
a cylindrical pocket, for locating and retaining the nodule.
